(19) United States
(12) Patent Application Publication
(10) Pub. No.: US 2009/0151630 A1
(43) Pub. Date: Jun. 18, 2009

(54) TENSIONED APERTURE MASK AND METHOD OF MOUNTING

(75) Inventors: Joseph A. Marcanio, Latrobe, PA (US); Jeffrey W. Conrad, Verona, PA (US)

Correspondence Address: THE WEBB LAW FIRM, P.C., 700 KOPPERS BUILDING, 436 SEVENTH AVENUE, PITTSBURGH, PA, 15219, US

(73) Assignee: ADVANTECH GLOBAL, LTD., Tortola (VG)

(21) Appl. No.: 12/299,531

(22) PCT Filed: Nov. 1, 2006
(86) PCT No.: PCT/US06/42858

§ 371 Date: Nov. 4, 2008

Related U.S. Application Data
(60) Provisional application No. 60/799,368, filed on May 10, 2006.

(51) Int. Cl. B29C 65/02; B05C 11/00

(52) U.S. Cl. 118/504; 156/285

(57) ABSTRACT

In a method of preparing and using an aperture mask, a temperature of an aperture mask is increased to a first, mounting temperature (T1), whereupon the size of the aperture mask increases according to its coefficient of thermal expansion (CTEam), until at least one dimension thereof is of a first desired extent. The temperature of a frame is also increased to T1, whereupon the size of the frame grows according to its coefficient of thermal expansion (CTEf), which is lower than CTEam. The aperture mask is fixedly mounted to the frame at T1. The frame mounted aperture mask is then used for depositing a material on a substrate at a deposition temperature T2 that is less than T1, whereupon the frame holds the shadow mask in tension with the one dimension at a second desired extent.

### BACKGROUND OF THE INVENTION

1. Field of the Invention

The present invention relates to aperture masks for depositing materials on substrates and, more particularly, to a method of forming and using aperture masks that enables the aperture masks to have desired dimensions during deposition.

2. Description of Related Art

An aperture mask, also known as a shadow mask, is a device that is typically used for depositing a desired pattern of material on a substrate. An aperture mask can be utilized for depositing a thin film pattern of material on a substrate in a vacuum deposition chamber via vapor deposition process known in the art or can be utilized for depositing a thick film pattern of material, such as a solder paste, on a substrate in a screen printing process known in the art.

Desirably, an aperture mask is made with very tight control of its dimensional tolerance to ensure that its features, e.g., apertures, have the correct size and/or position required. In addition, the aperture mask is desirably flat to ensure intimate contact with the substrate on which the material pattern is being formed to avoid underspray. The aperture mask is also desirably thermally stable, whereupon it does not change dimensional tolerance or flatness at deposition temperature. Lastly, the thickness of the aperture mask is desirably small to allow minimal feature size and minimal deposition shadowing.

Aperture masks with very fine features are typically electroformed rather than etched in order to produce apertures that are not only small, but with small distance between them. In this process, structures, i.e., apertures, are created by selectively electroplating metal onto a conductive mandrel, which has been patterned with areas of non-conductive photoresist. The patterned electroplated material, or aperture mask, is later removed from the mandrel. Resolution of the aperture mask is therefore only limited by the resolution capability of the non-conductive photoresist.

In the electroforming process, photoresist can be patterned onto the mandrel with suitable accuracy and precision. However, the electroplated metal typically exhibits some degree of stress, either compressive or tensile, depending on plating conditions. When removed from the mandrel, the internal stress will cause the aperture mask to expand (compressive) or contract (tensile), resulting in dimensional errors of feature position. Thus, fabricating a shadow mask with extreme accuracy of feature positions by electroforming is difficult and expensive, if not impossible for increasing resolution and overall area.

To perform vapor deposition through an aperture mask, the aperture mask must be held flat and in intimate contact with the substrate in order to avoid seepage of the evaporated material behind the mask onto the substrate in unintended area(s). To achieve this, the thin aperture mask is commonly bonded to a rigid frame by one of various well-known methods and is often mounted under tension in one direction, X or Y, to assure flatness. However, heretofore, no known means existed for creating tension in multiple directions, e.g., X and Y, of an aperture mask because such multi-direction tension created a tear or wrinkle in the aperture mask, typically in a corner.

Prior art aperture mask mounting systems were designed to accommodate thermal expansion of the aperture mask due to absorption of heat from the vapor deposition process. Spring loaded mounting systems have been explored, but none have been found suitable due to the formation of tears or corner wrinkles in the aperture mask and, in any case, expansion of the aperture mask created unacceptable positional error.

Shadow mask materials of extremely low coefficient of thermal expansion (CTE), such Invar®, have been used in order to control expansion of the aperture mask. However, even slight expansion creates results in underspray and dimensional shift.

What is, therefore, needed is a method of preparing an aperture mask that will ensure that when the aperture mask is in use the dimensions of the aperture mask are of a desired extent (length, width, thickness, etc.) at the temperature that the aperture will be utilized for depositing a pattern of material on a substrate.

### SUMMARY OF THE INVENTION

In accordance with the present invention, an aperture mask is stretched on a frame by thermal contraction of the aperture mask material. More specifically, an aperture mask of relatively high CTE is mounted to a frame of relatively lower CTE while both are at a desired elevated temperature. As the frame mounted aperture mask cools, the difference in CTE between the aperture mask and the frame causes the aperture mask to become tensioned in at least the X and Y directions because it is fixed to the low expansion frame and is not permitted to contract according to its own CTE. When in use, the aperture mask is held in tension and does not expand according to its own CTE, provided the temperature does not exceed the mounting temperature.

The invention is a method of preparing and using an aperture mask. The method includes (a) causing a temperature of an aperture mask to increase to a first, mounting temperature (T1), whereupon the size of the aperture mask increases according to its coefficient of thermal expansion (CTEₐₘ), until at least one dimension thereof is of a desired extent; (b) increasing the temperature of a frame to T1, whereupon the size of the frame grows according to its coefficient of thermal expansion (CTE_{f}), which is lower than CTEₐₘ; (c) fixedly mounting the aperture mask to the frame at T1; and (d) allowing the temperature of the frame mounted aperture mask to decrease from T1, whereupon the difference between CTE_{f} and CTEₐₘ causes the frame to hold the aperture mask in tension in more than one dimension without deforming the aperture mask.

The method can further include: (e) following step (d), installing the frame mounted aperture mask in a deposition vacuum vessel; (f) following step (e), evacuating the deposition vacuum vessel to a desired deposition pressure; and (g) following step (f), depositing material from a material deposition source in the deposition vacuum vessel on to a substrate in the deposition vacuum vessel via the frame mounted aperture mask in the presence of the desired deposition pressure, whereupon the deposition process causes the temperature of the aperture mask and the frame to increase to a second, deposition temperature (T2) that is less than T1 whereupon the CTE_{f} and the CTEₐₘ cause the frame to hold the aperture mask under tension in more than one dimension that is less than the tension in step (d) without deforming the aperture mask. Optionally, a cooling fluid can be provided to a cooling jacket of the frame during step (g).

Alternatively, the method can further include: (e) following step (d), positioning the frame mounted aperture mask in operative relation to a substrate; and (f) following step (e), depositing material on to the substrate via the frame mounted aperture mask, whereupon the temperature of the aperture mask and the frame during deposition is at a second, ambient deposition temperature (T2) that is less than T1.

The deposited material can be a solder paste.

T1 can be determined as a function of the combination of CTEₐₘ and a second, deposition temperature (T2) of the aperture mask during use. T2 can be less than T1.

T1 can equal T2+(Xₜ−Xₐ)/(Xₜ*CTEₐₘ), where Xₜ=target dimension of the aperture mask at T1; and Xₐ=actual, measured dimension of the aperture mask at a starting temperature T0, e.g., room or ambient temperature, that is below T2.

Alternatively, T1 can equal T2+((Xₜ−Xₐ)/(Xₜ*CTEₐₘ))+((CTE_{f}*(T1−T2))/CTEₐₘ), where Xₜ=target dimension of the aperture mask at T1; and Xₐ=actual, measured dimension of the aperture mask at a starting temperature T0, e.g., room or ambient temperature, that is below T2.

The force of the tension can be predetermined.

The invention is also a method of preparing and using an aperture mask. The method includes: (a) providing an aperture mask that is held in tension in more than one dimension by a frame during deposition of material on a substrate at a deposition temperature that is less than a mounting temperature where the aperture mask is not held in tension by the frame which has a lower coefficient of thermal expansion (CTE) than the aperture mask; (b) positioning the frame mounted aperture mask in operative relation to the substrate; and (c) while the frame and the aperture mask are at the deposition temperature, depositing material on the substrate via the aperture mask held in tension in more than one dimension by the frame.

In step (b), the frame mounted aperture mask can also be positioned in a vacuum deposition vessel; and the method can further include evacuating the vacuum deposition vessel to a desired deposition pressure prior to step (c).

The temperature of the frame mounted aperture mask can change to the deposition temperature in response to the process used to deposit the material on the substrate via the aperture mask in the presence of the desired deposition pressure.

Alternatively, the deposition temperature can be ambient temperature.

The method can further include: electroforming a pattern in the aperture mask whereupon, in the absence of the electroformed aperture mask being held in tension by the frame, the electroformed aperture mask has a least one dimension of less than a desired extent at the deposition temperature; and mounting the electroformed aperture mask to the frame at the mounting temperature, whereupon at the deposition temperature the frame holds the electroformed aperture mask in tension with the one dimension at the desired extent.

Lastly, the invention is a frame mounted aperture mask that includes an aperture mask that is held in tension in more than one dimension by a frame at a deposition temperature where the frame mounted aperture mask is used for depositing material on a substrate.

The frame is desirably made from a material that has a lower coefficient of thermal expansion (CTE) than the material from which the aperture mask is made. Subject to this requirement, the frame can be made from invar®, ceramic/glass, kovar®, tungsten, iron/steel, nickel or gold and the aperture mask can be made from ceramic/glass, kovar®, tungsten, iron/steel, nickel, gold, copper, silver or aluminum.

The aperture mask can be electroformed to have at least one dimension that is not of a desired extent when the frame is not held in tension by the frame at the deposition temperature. The electroformed aperture mask can be mounted to the frame at a mounting temperature that is greater than the deposition temperature, whereupon at the deposition temperature the frame holds the electroformed aperture mask in tension with the one dimension at the desired extent.

### BRIEF DESCRIPTION OF THE DRAWINGS

FIG. 1 is an exploded perspective view of a system for preparing a tensioned aperture mask in accordance with the present invention;

FIG. 2. is an isolated perspective view of a frame mounted tensioned aperture mask made according to the present invention;

FIG. 3 is a schematic view of a frame mounted tensioned aperture mask in accordance with the present invention disposed in a deposition vacuum vessel in operative relation to a material deposition source and a substrate onto which material from the material deposition source is deposited via the frame mounted tensioned aperture mask;

FIG. 4 is a schematic view of a frame mounted tensioned aperture mask in accordance with the present invention utilized in a screen printing process; and

FIG. 5 is a matrix of frame materials and aperture mask materials showing possible combinations thereof that can be utilized to form a tensioned aperture mask in accordance with the present invention.

### DETAILED DESCRIPTION OF THE INVENTION

The present invention will described with reference to the accompanying figures where like reference numbers correspond to like elements.

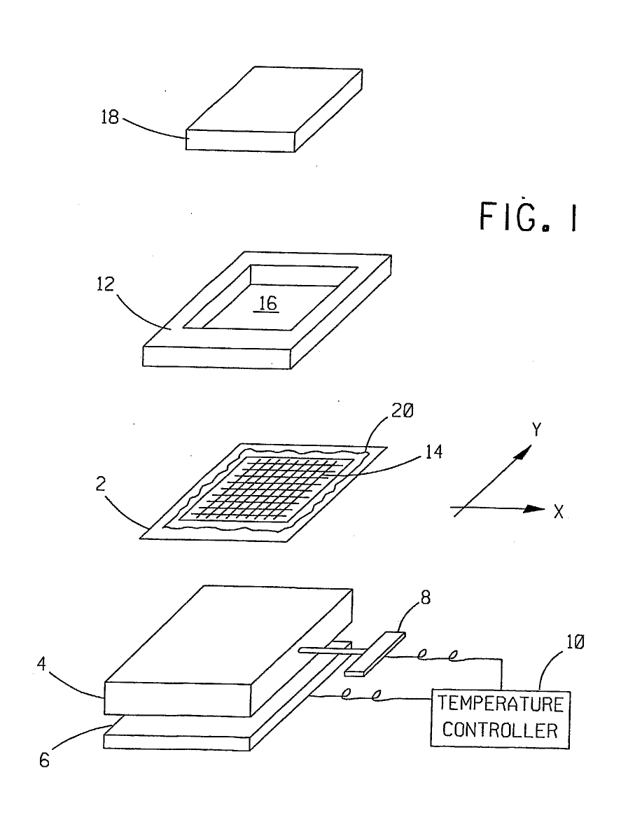

With reference to FIG. 1, in a method to establish an aperture mask 2 under tension, aperture mask 2 is heated to a first, mounting temperature (T1) by any suitable or desirable means. One such means of increasing the temperature of aperture mask 2 to temperature T1 is the combination of a heating block 4 and a heating element 6. However, this is not to be construed as limiting the invention.

Heating block 4 is made from any suitable and/or desirable material that retains heat that is generated by heating element 6 in contact with heating block 4. A temperature sensing element 8 can be disposed in operative relation to heating block 4. Temperature sensing element 8 can be coupled to an input of a temperature controller 10 which has an output connected to heating element 6 to form a closed loop heating control system for controlling the temperature of heating block 4. Temperature controller 10 can be of any suitable and/or desirable type selected by one of ordinary skill in the art.

At a suitable time, aperture mask 2 in contact with heating block 4 is heated via heating block 4 and heating element 6 from a starting temperature (T0), e.g., room or ambient temperature, to temperature T1 whereupon the size of aperture mask 2 increases according to its coefficient of thermal expansion (CTEₐₘ) until at least one dimension thereof increases to a desired extent, e.g., length.

Concurrent with heating aperture mask 2 to temperature T1, a frame 12 placed in contact with aperture mask 2 on heating block 4 is also heated to temperature T1, whereupon the size of frame 12 grows according to its coefficient of thermal expansion (CTE_{f}). In accordance with the present invention, CTE_{f} is lower than CTEₐₘ.

When heating block 4 is utilized to heat aperture mask 2 and frame 12 to temperature T1, frame 12 is in contact with a side of aperture mask 2 adjacent the periphery or border thereof such that the apertures 14 of aperture mask 2 are in alignment with an opening 16 in frame 12.

In FIG. 1, aperture mask 2 is shown in contact with a surface of heating block 4 opposite heating element 6 and frame 12 is shown in contact with a side of aperture mask 2 opposite heating block 4. However, this is not to be construed as limiting the invention since the positions of aperture mask 2 and frame 12 can be reversed if desired. For purpose of describing the present invention, however, it will be assumed that the positions of aperture mask 2 and frame 12 on heating block 4 are as shown in FIG. 1. However, this is not to be construed as limiting the invention.

During heating of aperture mask 2 and frame 12, it is desirable, but not required, to position a planarizing block 18 on the apertures 14 portion of aperture mask 2 via opening 16 in frame 12. Planarizing block 18 helps maintain the apertures portion 14 of aperture mask 2 planar during heating thereof to temperature T1.

A process of determining the actual temperature T1 where aperture mask 2 is mounted to frame 12 will now be described with reference to the following numerical example.

Suppose aperture mask 2 has a dimension Xₐ at a starting temperature T0, e.g., room or ambient temperature, equal to 99.980 mm and that the target mask dimension Xₜ of aperture mask 2 at a projected deposition temperature T2, e.g., 85° F. (29.45° C.), is 100.000 mm, a difference of 0.020 mm. Temperature T2 of 85° F. (29.45° C.) is not to be construed as limiting the invention since it is envisioned that the combination of aperture mask 2 and frame 12 can be utilized at any suitable and/or desirable temperature T2, including, room or ambient temperature T0.

Given the foregoing information along with a value of CTEₐₘ equal to 7.5×10⁻⁶ mm/mm° F. (13.39×10⁻⁶ mm/mm° C.), the temperature T1 that aperture mask 2 is mounted to frame 12 is estimated utilizing the following equation EQ 1 to be 98.33° F. (36.85° C.).

T1=T2+(Xₜ−Xₐ)/((Xₜ)(CTEₐₘ)) EQ 1

where:
CTEₐₘ=coefficient of thermal expansion of the aperture mask, e.g., 7.5×10⁻⁶ mm/mm° F. (13.39×10⁻⁶ mm/mm° C.);
Xₜ target mounting dimension of the aperture mask at temperature T1, e.g., 100.000 mm;
Xₐ=actual, measured dimension of the aperture mask at a starting temperature T0, e.g., 99.980 mm; and
T2=projected deposition temperature, e.g., 85° F. (29.45° C.).

The temperature T1 determined by EQ 1 is an estimate of the temperature that both aperture mask 2 and frame 12 must be at in order to form a tensioned aperture mask in accordance with the present invention. However, in order to determine the actual temperature T1 where aperture mask 2 is mounted to frame 12, it is necessary to determine a correction temperature (Tc) to be added to or subtracted from the estimated temperature T1 in EQ 1 to account for the effect of CTE_{f} on said estimated temperature.

Temperature Tc can be determined utilizing the following Equation 2:

Tc=CTE_{f}(T1−T2)/CTEₐₘ EQ 2

where:
CTE_{f}=coefficient of thermal expansion of the frame;
CTEₐₘ=coefficient of thermal expansion of the aperture mask;
T1=determined from EQ 1 above; and
T2=projected deposition temperature, e.g., 85° F. (29.45° C.).

Where CTEₐₘ and CTE_{f} have values of 7.5×10⁻⁶ mm/mm° F. (13.39×10⁻⁶ mm/mm° C.) and 0.9×10⁻⁶ mm° F. (1.607×10⁻⁶ mm/mm° C.), respectively, and temperatures T1 and T2 have values of 99.33° F. (36.85° C.) and 85° F. (29.45° C.), respectively, substituting these values into EQ 2 and solving EQ 2 for these values results in connection temperature Tc having a value of 1.6° F. (0.89° C.).

Once temperature Tc has been determined, the actual, corrected value for temperature T1 can be determined utilizing the following equation 3:

T1=T1(from EQ 1)+Tc EQ 3

Substituting the above-determined values of 98.33° F. (36.85° C.) (from EQ 1) and 1.6° F. (0.89° C.) for T1 and Tc, respectively, into the right side of EQ 3 and solving EQ 3 for these values yields actual temperature T1 having a value of 99.93° F. (37.74° C.). This temperature is the actual temperature where aperture mask 2 is mounted to frame 12.

The following equation EQ 4 can be utilized to determine the difference in the extent of at least one dimension, e.g., length, of frame 12 between temperature T1 and T2:

ΔX_{f}=(Xₜ) (CTE_{f}) (T1−T2) EQ 4

where:
ΔX_{f}=change in an extent (length) of a dimension of frame 12 between temperature T1 and T2;
X_{f}=target dimension of frame 12 at deposition temperature T2;
CTE_{f}=coefficient of thermal expansion of frame 12;
T1 (From EQ 3)=actual temperature where aperture mask 2 is mounted to frame 12; and
T2=projected deposition temperature, e.g., 85° F. (29.45° C.).

Substituting 100.000 mm for Xₜ; 0.9×10⁻⁶ mm/mm° F. (1.607×10⁻⁶ mm/mm° C.) for CTE_{f}; 99.93° F. (37.74° C.) for T1; and 85° F. (29.45° C.) for T2 in EQ 4 and solving EQ 4 for these values yields a value of 0.001344 mm for ΔX_{f}.

Having determined the corrected mounting temperature T1 utilizing equation EQ 3, a corrected aperture mask mounting dimension that accounts for the effect frame 12 has on the dimension(s) of aperture mask 2 mounted to frame 12 when cooled from temperature T1 determined in EQ 3 to the deposition temperature T2 can be determined utilizing the following equation EQ 5:

Xₜ=Xₜ(Used in EQ 1)+ΔX_{f} EQ 5

Substituting 100.000 mm for Xₜ and 0.0001344 mm for ΔXₜ on the right side of EQ 5 and solving EQ 5 for these values yields a corrected aperture mask mounting dimension of 100.001344 mm for Xₜ on the left side of EQ 5. Thus, in the foregoing example, the corrected mounting dimension Xₜ of aperture mask 2 at 99.93° F. (temperature T1 determined by EQ 3) ( (37.74° C.) is 100.001344 mm.

Prior to determining the solution for any one of equations EQ 1-EQ 5, it is first necessary to predetermine values of CTEₐₘ, CTE_{f} and temperature T2, as well as a value for Xₜ to be used in EQ 1. In addition, it is also desirable to establish a desired minimum tension (Tₘᵢₙ) to be applied to aperture mask 2 by frame 12 at starting or ambient temperature T0 and a maximum tension (Tₘₐₓ) to be applied to aperture mask 2 by frame 12 at starting or ambient temperature T0.

For example, suppose that it is predetermined that Tₘₐₓ and Tₘᵢₙ of aperture mask 2 equals 20,000 psi (137,900 kPa) and 2,000 psi (13,790 kPa), respectively, at temperature T0 and that Young's modulus (E) of the material forming aperture mask 2 is 20×10⁶ psi (137.9×10⁻⁶ kPa). Given these values and the target dimension Xₜ of aperture mask 2 at temperature T1 (e.g., 100.000 mm), the maximum dimension Xₘₐₓ and the minimum dimension Xₘᵢₙ of aperture mask 2 at temperature T0 can be determined utilizing the following equations EQ 6 and EQ 7.

Xₘₐₓ=Xₜ−[[Tₘᵢₙ][Xₜ]]/E; EQ 6

Xₘₐₓ=Xₜ−[[Tₘᵢₙ][Xₜ]]/E. EQ 7

Solving EQ 6 and EQ 7 for Xₜ=100.000 mm; T=2,000 psi (13,790 kPa); Tₘₐₓ=20,000 psi (137,900 kPa); and E=20×10⁶ psi (137.9×10⁻⁶ kPa) yields values of 99.990 mm and 99.950 mm for Xₘₐₓ and Xₘᵢₙ, respectively, at temperature T0. The values of Tₘᵢₙ and Tₘₐₓ can be selected empirically or theoretically. Regardless of how Tₘᵢₙ and Tₘₐₓ are selected, the values of Tₘᵢₙ and Tₘₐₓ are selected such that the strain induced in aperture mask 2 when mounted to frame 12 will be below the point at which plastic deformation occurs.

The thus determined values for Xₘᵢₙ and Xₘₐₓ represent the smallest and largest dimension Xₐ that aperture mask 2 should have at temperature T0 to avoid plastic deformation of aperture mask 2. However, due to manufacturing tolerances in the manufacture of aperture masks, it is necessary to produce aperture mask 2 having dimensions between Xₘᵢₙ and Xₘₐₓ to account for this tolerance. For example, if a manufacturer of aperture mask 2 has a control tolerance of any dimension of +/−0.005 mm, then the manufacturer will manufacture aperture mask 2 to ensure that dimension Xₐ falls between the values of Xₘᵢₙ and Xₘₐₓ established for said dimension. In the example described above in connection with EQ 1-EQ 5, the dimension Xₐ at temperature T0 is 99.980 mm, which is between +/−0.005 mm of Xₘᵢₙ=99.950 mm and Xₘₐₓ=99.990 mm.

Referring back now to heating aperture mask 2, frame 12 and, desirably, planarizing block 18, once aperture mask 2, frame 12 and planarizing block 18 have been allowed to soak at the corrected temperature T1 determined by EQ 3, the dimension Xₜ of aperture mask 2 is measured to ensure it is at the corrected aperture mask mounting dimension determined by EQ 5, e.g., 100.001344 mm. If not, the actual temperature T1 of aperture mask 2, frame 12 and planarizing block 18 is adjusted, either increased or decreased, as necessary until the dimension of aperture mask 2 is at the corrected aperture mask mounting dimension determined by EQ 5.

Once it has been determined that the dimension Xₜ of aperture mask 2 is at the corrected aperture mask mounting dimension determined by EQ 5, aperture mask 2 is mounted to frame 12, i.e., aperture mask 2 and frame 12 are bonded together, utilizing any suitable and/or desirable technique, such as adhesive, welding or mechanical clamping. An epoxy adhesive, such as E-20HP or E-120HP from Loctite Corporation have been used successfully. If welding is used, care must be taken to ensure that thermal excursions and the resultant expansion of aperture mask 2 and frame 12 are within tolerable limits.

For example, where an adhesive is to be utilized to bond aperture mask 2 and frame 12 together, aperture mask 2 and frame 12 are placed on heating block 4 with planarizing block 18 positioned on the apertures 14 portion of aperture mask 2 via opening 16 in frame 12.

Thereafter, aperture mask 2, frame 12 and planarizing block 18 are heated to the actual temperature T1 determined by EQ 3 and allowed to soak at said temperature for a sufficient period of time to stabilize and minimize temperature gradients.

The corrected extent (length) of dimension Xₜ of aperture mask 2 determined by EQ 5 is then measured. If the measured extent of this dimension Xₜ does not match the corrected extent of dimension Xₜ determined by EQ 5, the actual temperature T1 is adjusted by way of temperature controller 10, heating element 6 and heating block 4 in a manner known in the art. This process is repeated until the measured extent of dimension Xₜ equals the corrected extent of dimension Xₜ determined by EQ 5.

Once the measured extent of dimension Xₜ has stabilized at the corrected extent determined by EQ 5, an adhesive 20 is introduced between frame 12 and aperture mask 2. To facilitate the introduction of adhesive 20, frame 12 is removed from contact with aperture mask 2, adhesive 20 is applied to aperture mask 2, and frame 12 is then repositioned on aperture mask 2 with frame 12 and aperture mask 12 both in contact with adhesive 20.

Next, frame 12 and aperture mask 2 are secured, i.e., clamped together, utilizing any suitable and/or desirable means, in a manner that enables aperture mask 2 and frame 12 to remain at the actual temperature T1 where the measured extent of dimension Xₜ equals the corrected extent of dimension determined by EQ 5 during the time adhesive 20 is curing. For example, in the instance where aperture mask 2 is in contact with heating block 4 and frame 12 is positioned on a side of aperture mask 2 opposite heating block 4, one or more C-clamps (not shown) can be applied between the side of frame 12 opposite aperture mask 2 and the side of heating block 4 adjacent heating element 6. However, this is not to be construed as limiting the invention.

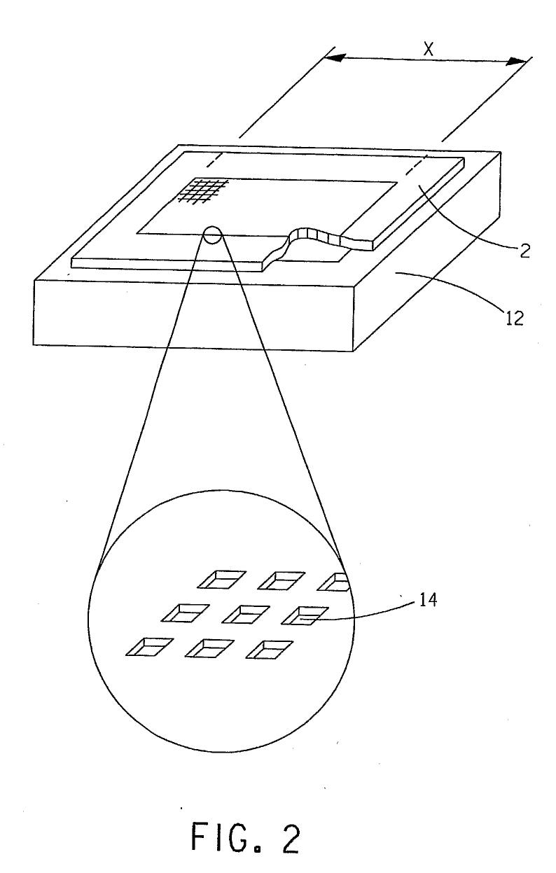

With reference to FIG. 2, once adhesive 20 has cured for a desired curing interval, the assembled aperture mask 2 and frame 12 (or frame 12 mounted aperture mask 2) is removed from heating block 4 and allowed to cool.

Because the coefficient of thermal expansion of frame 12 (CTE_{f}) is less than the coefficient of thermal expansion of aperture mask 2 (CTEₐₘ), in response to the assembly cooling, the dimensions of aperture mask 2 will attempt change to a greater extent than the dimensions of frame 12. However, aperture mask 2 will be held in tension in both the X and Y directions by frame 12 at temperatures below the actual mounting temperature T1 determined by EQ 3. By careful selection of the materials forming aperture mask 2 and frame 12, the actual dimensions of aperture mask 2 at the projected deposition temperature T2 can be assured, if not exactly, then within reasonable tolerance.

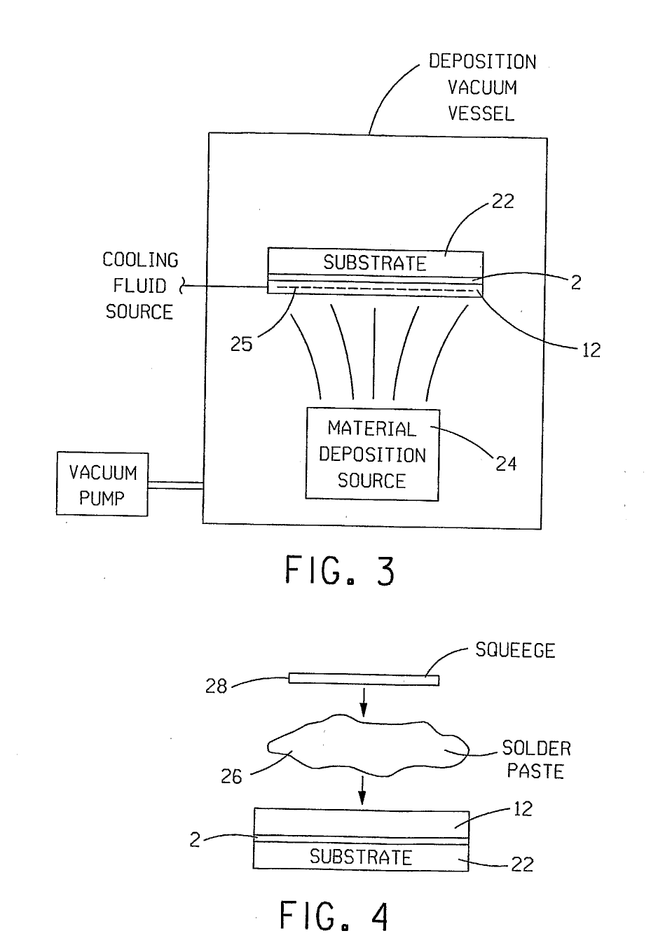

With reference to FIG. 3, in one exemplary use, the assembly comprising frame 12 mounted aperture mask 2 is included in a deposition vacuum vessel in operative relation to a substrate 22 and a material deposition source 24 for use in connection with a suitable vacuum deposition process, e.g., sputtering, vapor phase deposition, etc., in the presence of a suitable vacuum. In this exemplary use, the material deposition process itself will cause the temperature of the assembly to increase from ambient temperature T0 to deposition temperature T2, which is less than the actual mounting temperature T1. Accordingly, at deposition temperature T2, aperture mask 2 will be held in tension in both X and Y directions by frame 12, albeit at a lesser tension than before the material deposition process. For example, prior to being utilized in a vacuum deposition process, the assembly may be at ambient temperature T0 where frame 12 holds aperture mask 2 under a first tension force (Tₘₐₓ) greater than a second tension force (Tₘᵢₙ) applied to aperture mask 2 by frame 12 at deposition temperature T2 during the vacuum deposition process. The material forming aperture mask 2 is selected whereupon when frame 12 holds aperture mask 2 at the first tension force or the second tension force, aperture mask 2 is not plastically deformed thereby.

To facilitate accurate control of deposition temperature T2 that frame 12 mounted aperture mask 2 is at during deposition of material from material deposition source 24 onto substrate 22, frame 12 can optionally include a cooling jacket 25 connected to a suitable cooling fluid source for passage of a cooling fluid, such as, a cooling liquid, e.g., water, a cooling gas, e.g., nitrogen, and the like. Cooling jacket 25 enables the deposition temperature T2 of frame 12 and aperture mask 2 to be more accurately controlled than the use of frame 12 mounted aperture mask 2 without cooling jacket 25.

By mounting aperture mask 2 to frame 12 at the actual temperature T1 determined by EQ 3, the dimensions of aperture mask 2 at the deposition temperature T2 can be assured within reasonable tolerance. Thus, each feature or aperture 14 of aperture mask 2 will be at a desired location, desirably within acceptable tolerance, with little or no run-on error.

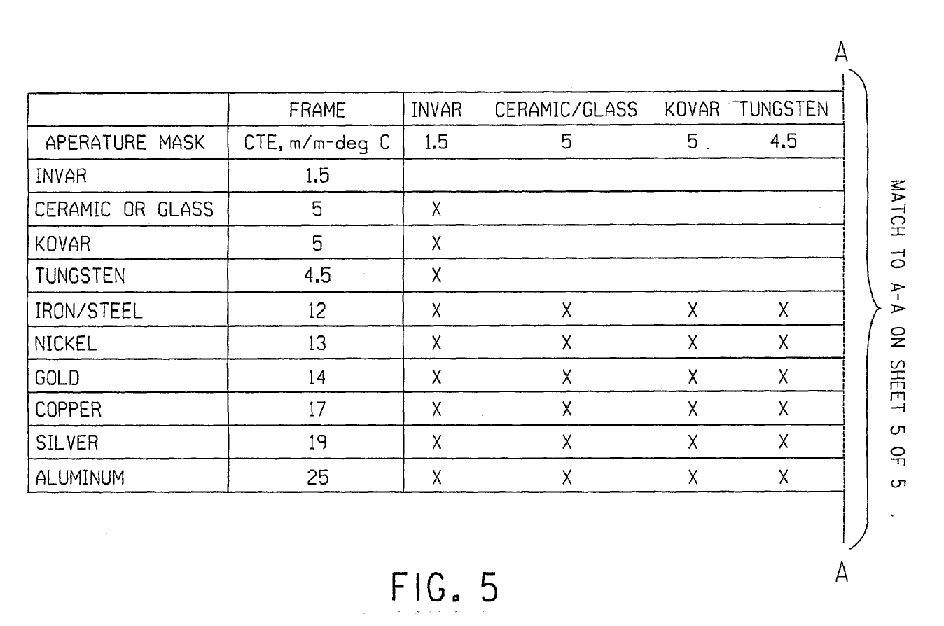

With reference to FIG. 4, while the use of the assembly comprising frame 12 mounted aperture mask 2 has been described in connection with a vacuum deposition process at an elevated deposition temperature T2, it is to be appreciated that the assembly can also be designed to be utilized at an ambient deposition temperature T2 i.e., temperature T2 equals temperature T0, in a screen printing process where frame 12 mounted aperture mask 2 is positioned in operative relation to substrate 22 for application of a solder paste 26 onto substrate 22 by way of a squeegee 28 and aperture mask 2. In this case, the actual mounting temperature T1 determined by EQ 3 will be determined as a function of this lower deposition temperature T2 in the manner described above in connection with equations EQ 1-EQ 3. Accordingly, a detailed description of the mounting of aperture mask 2 to frame 12 for use thereof at ambient temperature will not be described herein to avoid unnecessary redundancy.

As can be seen, the present invention is a method for stretching aperture mask 2 on a frame 12 by thermal contraction of the material forming aperture mask 2. More specifically, aperture mask 2 of relatively high CTE is affixed to a frame of a relatively lower CTE while both are at a desired actual mounting temperature TI. As the assembly comprising frame 12 mounted aperture mask 2 cools, the difference in CTE between frame 12 and aperture mask 2 causes aperture mask 2 to become tensioned because it is fixed to frame 12 having a lower CTE, whereupon aperture mask 2 is not permitted to contract according to its CTE. In use, because aperture mask 2 is held in tension by frame 12 at a desired deposition temperature T2, the dimensions of aperture mask 2 can be assured, within acceptable tolerance, whereupon features or apertures 14 of aperture mask 2 will be at desired locations at deposition temperature T2 and so-called run-on errors caused by uncontrolled expansion of aperture mask 2 is/are avoided.

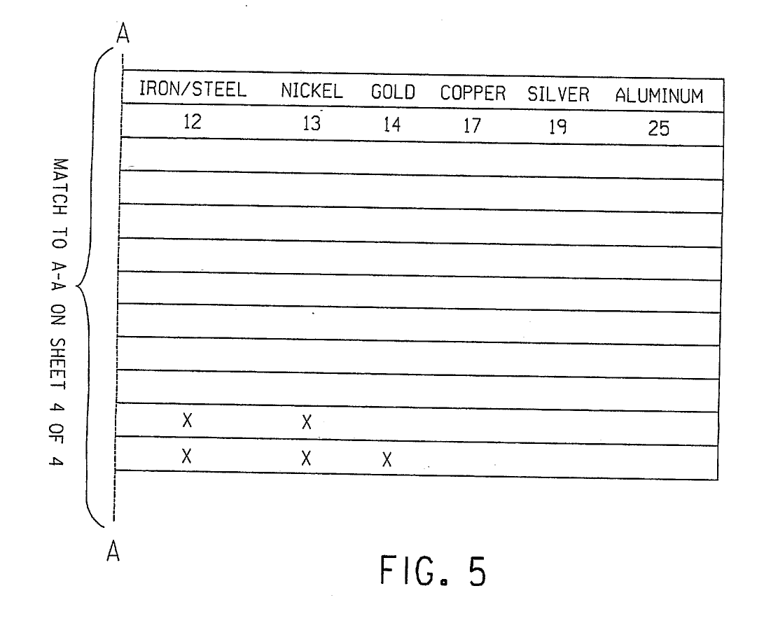

With reference to FIG. 5, a matrix of possible combinations of aperture mask 2 and frame 12 materials is shown. However, the materials included in this matrix are not to be construed as limiting the invention since the use of any suitable and/or desirable material for aperture mask 2, frame 12, or both is envisioned.

In FIG. 5, one exemplary combination can include frame 12 made of Invar® and aperture mask 2 made of Kovar®. Invar® is a registered trademark in the United States of America of Imphy S.A. Corporation of Paris, France (registration no. 0,063,970). Kovar® is a registered trademark in the United States of America of Westinghouse Electric & Manufacturing Company Corporation of Pittsburgh, Pa., USA (registration no. 0,337,962).

As can be seen, the present invention is a novel and non-obvious method for mounting and using an aperture mask that ensures apertures in the aperture mask are at desired locations during a deposition process occurring at a desired deposition temperature. The present invention eliminates or avoids the misregistration of features associated with aperture masks 2 made and used in accordance with the prior art.

The present invention has been described with reference to the preferred embodiments. Obvious modifications and alterations will occur to others upon reading and understanding the preceding detailed description. For example, while cooling jacket 25 was described in connection with frame 12 mounted aperture mask 2 in a deposition vacuum vessel, it is to be appreciated that frame 12 mounted aperture mask 2 to be utilized in the screen printing process shown in FIG. 4 can also include a cooling jacket 25 to facilitate more accurate control of the deposition temperature T2 thereof. It is intended that the invention be construed as including all such modifications and alterations insofar as they come within the scope of the appended claims or the equivalents thereof.

The invention claimed is:

1. A method of preparing and using an aperture mask comprising:
(a) causing a temperature of an aperture mask to increase to a first, mounting temperature (T1), whereupon the size of the aperture mask increases according to its coefficient of thermal expansion (CTEₐₘ), until at least one dimension thereof is of a desired extent;
(b) increasing the temperature of a frame to T1, whereupon the size of the frame grows according to its coefficient of thermal expansion (CTE_{f}), which is lower than CTEₐₘ;
(c) fixedly mounting the aperture mask to the frame at T1; and
(d) allowing the temperature of the frame mounted aperture mask to decrease from T1, whereupon the difference between CTE_{f} and CTEₐₘ causes the frame to hold the aperture mask in tension in more than one dimension without deforming the aperture mask.

2. The method of claim 1, further including:
(e) following step (d), installing the frame mounted aperture mask in a deposition vacuum vessel;
(f) following step (e), evacuating the deposition vacuum vessel to a desired deposition pressure; and
(g) following step (f), depositing material from a material deposition source in the deposition vacuum vessel on to a substrate in the deposition vacuum vessel via the frame mounted aperture mask in the presence of the desired deposition pressure, whereupon the deposition process causes the temperature of the aperture mask and the frame to increase to a second, deposition temperature (T2) that is less than T1, whereupon the CTE_{f} and the CTEₐₘ cause the frame to hold the aperture mask in tension in more than one dimension that is less than the tension in step (d) without deforming the aperture mask.

3. The method of claim 2, further including supplying a cooling fluid to a cooling jacket of the frame during step (g).

4. The method of claim 1, further including:
(e) following step (d), positioning the frame mounted aperture mask in operative relation to a substrate; and
(f) following step (e), depositing material on to the substrate via the frame mounted aperture mask, whereupon the temperature of the aperture mask and the frame during deposition is at a second, ambient deposition temperature (T2) that is less than T1.

5. The method of claim 4, wherein the deposited material is a solder paste.

6. The method of claim 1, wherein:
T1 is determined as a function of the combination of CTEₐₘ and a second, deposition temperature (T2) of the aperture mask during use; and
T2 is less than T1.

7. The method of claim 6, wherein:
T1=T2+(Xₜ−Xₐ)/((Xₜ)(CTEₐₘ))
wherein:
Xₜ target dimension of the aperture mask at T1; and
Xₐ actual, measured dimension of the aperture mask at a starting temperature T0, e.g., room or ambient temperature, that is below T2.

8. The method of claim 6, wherein:
T1=T2+((Xₜ−Xₐ)/((Xₜ)(CTEₐₘ))+((CTE_{f}(T1−T2))/CTEₐₘ)
wherein:
Xₜ target dimension of the aperture mask at T1; and
Xₐ actual, measured dimension of the aperture mask at a starting temperature T0, e.g., room or ambient temperature, that is below T2.

9. The method of claim 2, wherein the force of the tension is predetermined.

10. A method of preparing and using an aperture mask comprising:
(a) providing an aperture mask that is held in tension in more than one dimension by a frame during deposition of material on a substrate at a deposition temperature that is less than a mounting temperature where the aperture mask is not held in tension by the frame which has a lower coefficient of thermal expansion (CTE) than the aperture mask;
(b) positioning the frame mounted aperture mask in operative relation to the substrate; and
(c) while the frame and the aperture mask are at the deposition temperature, depositing material on the substrate via the aperture mask held in tension in more than one dimension by the frame.

11. The method of claim 10, wherein:
in step (b), the frame mounted aperture mask is also positioned in a vacuum deposition vessel; and
the method further includes evacuating the vacuum deposition vessel to a desired deposition pressure prior to step (c).

12. The method of claim 11, wherein the temperature of the frame mounted aperture mask changes to the deposition temperature in response to the process used to deposit the material on the substrate via the aperture mask in the presence of the desired deposition pressure.

13. The method of claim 10, wherein the deposition temperature is either ambient temperature or a temperature controlled by a cooling fluid passing through a cooling jacket of the frame during step (c).

14. The method of claim 10, further including:
electroforming a pattern in the aperture mask whereupon, in the absence of the electroformed aperture mask being held in tension by the frame, the electroformed aperture mask has a least one dimension of less than a desired extent at the deposition temperature; and
mounting the electroformed aperture mask to the frame at the mounting temperature, whereupon at the deposition temperature the frame holds the electroformed aperture mask in tension with the one dimension at the desired extent.

15. A frame mounted aperture mask comprising an aperture mask that is held in tension in a plurality of dimensions by a frame at a deposition temperature where the frame mounted aperture mask is used for depositing material on a substrate.

16. The frame mounted aperture mask of claim 15, wherein the frame is made from a material that has a lower coefficient of thermal expansion (CTE) than the material from which the aperture mask is made.

17. The frame mounted aperture mask of claim 16, wherein:
the aperture mask is electroformed to have at least one dimension that is not of a desired extent when the frame is not held in tension by the frame at the deposition temperature; and
the electroformed aperture mask is mounted to the frame at a mounting temperature that is greater than the deposition temperature, whereupon at the deposition temperature the frame holds the electroformed aperture mask in tension with the one dimension at the desired extent.

18. The frame mounted aperture mask of claim 16, wherein the frame is made from invar®, ceramic/glass, kovar®, tungsten, iron/steel, nickel or gold.

19. The frame mounted aperture mask of claim 16, wherein the aperture mask is made from ceramic/glass, kovar®, tungsten, iron/steel, nickel, gold, copper, silver or aluminum.
